(19) United States
(12) Patent Application Publication
(10) Pub. No.: US 2005/0264756 A1
(43) Pub. Date: Dec. 1, 2005

(54) Custom contact lens molding system and methods

(75) Inventor: Victor C. Esch, Albuquerque, NM (US)

Correspondence Address: LUCE, FORWARD, HAMILTON & SCRIPPS LLP, 11988 EL CAMINO REAL, SUITE 200, SAN DIEGO, CA, 92130, US

(73) Assignee: PowerVision, Inc., San Francisco, CA (US)

(21) Appl. No.: 11/130,556

(22) Filed: May 16, 2005

Related U.S. Application Data
(60) Provisional application No. 60/570,995, filed on May 14, 2004.

(51) Int. Cl. G02C 7/04

(52) U.S. Cl. 351/160 R

(57) ABSTRACT

Apparatus and methods for manufacturing custom contact lenses and molds is provided wherein a reconfigurable mold has a cavity including deformable surface that is deformed by an array of actuators to define a specified surface contour that will result in a desired wavefront. The specified surface contour may be imparted to moldable material deposited in the cavity, and the array of actuators may be repositioned to optimize the vision correction provided by the custom contact lens. Methods of using the reconfigurable mold to manufacture custom contact lens molds also are provided.

### FIELD OF THE INVENTION

The present invention relates to apparatus and methods for producing custom contact lenses or other optical elements. More particularly, the present invention relates to a molding system including at least one deformable surface having localized deflections controlled by an array of actuators.

### BACKGROUND OF THE INVENTION

The use of contact lenses to correct for imperfect vision is now commonplace, and there are a vast number of lens products available to the public that are typically quite inexpensive. Among these products are “toric” contact lenses, designed to correct the common visual defect of astigmatism. This aberration arises from an asymmetry of the curvature of the cornea. An astigmatic surface may be described by two radii of curvature, denoted as major and minor radii, and the orientation of the two axes.

Many other aberrations may adversely impact the imaging properties of an eye. Such aberrations may conveniently be described by Zernike polynomial expansion of the deviation of the wavefront from that of an ideal spherical wave. Such ortho-normal expansions have a number of convenient properties for the mathematical and clinical description of the properties of the eye. Astigmatism may be described by the fourth and fifth coefficients of the Zernike expansion. There are numerous other aberrations that may affect vision, for example coma, higher order sphere, and trefoil, among others.

Recent advances in the field of LASIK technology have allowed higher order aberrations to be treated by sculpting of the cornea. Although this procedure has resulted in some success, it is not without limitations. For example, use of LASIK may be contraindicated based on the thickness of the cornea. If it is desired to produce a long radius surface on a relatively short radius cornea, the thickness of the corneal tissue in the center of the cornea may become prohibitively thin. Other limitations may arise at the transition zone where a newly sculpted surface joins a native surface.

To overcome the foregoing limitations of previously-known vision correction systems and methods, it would be desirable to provide a contact lens having increased customization compared to previously-known lenses.

It further would be desirable to provide a system for fabricating contact lenses that is simple to operate and inexpensive.

### SUMMARY OF THE INVENTION

In view of the foregoing, it is an object of the present invention to provide apparatus and methods to fabricate customized contact lenses.

It is also an object of this invention is to provide a system for fabricating custom contact lenses that are tailored to reduce or cancel the higher order aberrations of the eye. Unlike previously-known toric contact lenses, which are limited by rotational and blink-related movement, the system of the present invention is expected to provide tailored contact lenses that will register with the topography of the cornea with little or no movement or rotation.

It is a further object of the present invention is to provide a system for fabricating custom contact lenses that is easy to use and inexpensive.

These and other objects of the present invention are accomplished by providing apparatus and methods for molding custom lenses having a mold including at least one deformable surface, wherein localized deflection of the deformable surface is selectively imposed by an array of actuators. In this manner, a desired surface configuration may be impressed upon the deformable surface, and thereby transferred to material within the mold.

In a preferred embodiment, a custom contact lens is formed by deforming a moldable blank of material. For example, a disc-shaped piece of molded material may be placed within the mold so that at least one surface of the material contacts a first side of a deformable surface within the mold. An array of actuators, which may be electrically, pneumatically or hydraulically controlled, is disposed in contact with a second side of the deformable surface to impose localized deflections on the deformable surface. By varying the magnitude and location of the localized deflections created by the array of actuators, a predetermined surface contour may be impressed onto the moldable material via the deformable surface, including any required asymmetry. The material then may be hardened, cured, or otherwise treated to help retain the impressed surface contour and to prevent further deformation.

In an alternative embodiment, the system of the present invention may be configured to fabricate custom molds (as opposed to lenses), with the custom molds subsequently being used to fabricate the lenses.

Methods of using the apparatus of the present invention also are provided.

### BRIEF DESCRIPTION OF THE DRAWINGS

The above and other objects and advantages of the present invention will be apparent upon consideration of the following detailed description, taken in conjunction with the accompanying drawings, in which like reference numerals refer to like parts throughout, and in which:

FIG. 1 is a schematic view of an exemplary embodiment of a system constructed in accordance with the principles of the present invention;

FIG. 2 is a schematic side view of an embodiment of a re-configurable molding device in accordance with the present invention;

FIG. 3 is a schematic top view of an embodiment of a re-configurable molding device in accordance with the present invention;

FIG. 4 is a schematic side view depicting actuators of an embodiment of a re-configurable molding device in accordance with the present invention;

FIG. 5 is a schematic side view depicting an embodiment of a re-configurable molding device in accordance with the present invention; and

FIG. 6 is a schematic side view of an embodiment of a custom mold constructed in accordance with the present invention.

### DETAILED DESCRIPTION OF THE INVENTION

The present invention is directed to systems and methods for forming custom lenses, and in particular, for forming contact lenses suitable for treating astigmatism and other higher order aberrations. Commercially available contact lens designs often provide only a limited degree of customization. The system and methods of the present invention permit enhanced customization of contact lenses, at lower cost and with greater ease-of-use than may be currently achievable.

Prior to fabricating a custom contact lens for a particular patient, the patient's vision deficiency must be assessed. Apparatus and methods for making this assessment are known, such as described in U.S. Pat. No. 6,598,975 to Liang, et al., which is hereby incorporated by reference in its entirety. The prescriptive information obtained using a wavefront measurement device then may be used as input for the custom contact lens fabrication system of the present invention. While this information generally originates with a patient, it also may be computed from data stored in other sources, such as statistical or historical data in the patient's file. The information may be transmitted manually, locally, or remotely to the system, where it is used as input for lens formation as described hereinafter.

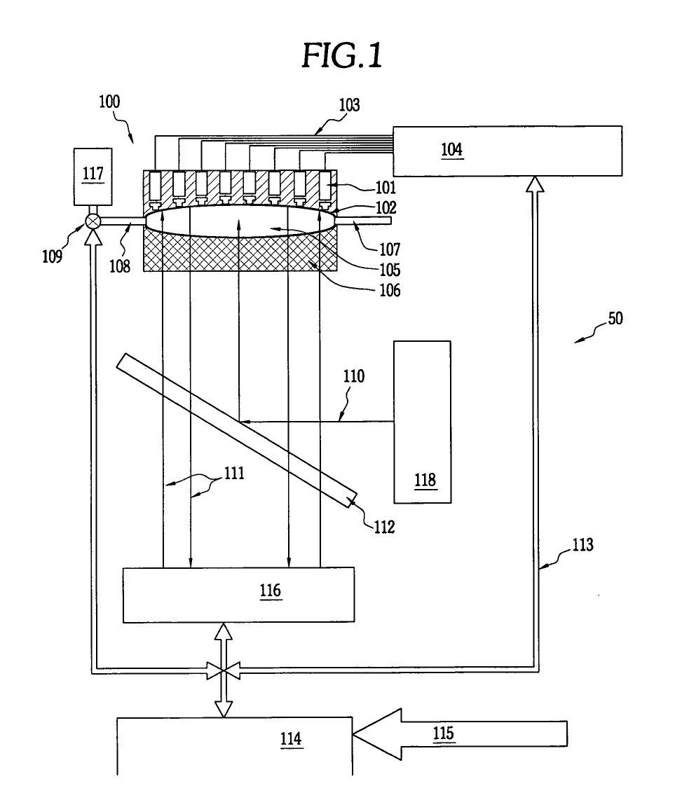

Referring to FIG. 1, lens fabrication system 50 of the present invention is described for use in tailoring at least one surface of a contact lens. System 50 includes reconfigurable mold 100 having actuators 101 disposed in housing 125 in contact with deformable surface 102. Deformable surface 102 and support member 106 together define cavity 105 that accepts material to be molded into a custom contact lens. Actuators 101 are controlled by lines 103 and actuator controller 104.

System 50 further comprises system controller 114, measurement system 116, material reservoir 117 and curing means 118, illustratively a lamp of predetermined wavelength. System controller 114 is coupled to actuator controller 104, measurement system 116 and material reservoir 117 via control lines 113. Moldable material is delivered into cavity 105 of reconfigurable mold 100 via manifold 108 and valve 109 under the control of system controller 114, while excess material is ejected from mold 100 via exit manifold 107.

Actuators 101 are configured to impose localized deflections on deformable surface 102 responsive to operation of system controller 114 and actuator controller 104. During manufacture of a custom contact lens, deflections of the actuators are integrated and smoothed by deformable surface 102 and then imposed upon moldable material disposed within cavity 105 of reconfigurable mold 100. Deformable surface 102 serves as a barrier to prevent material deposited in mold 100 from making direct contact with actuators 101. Alternatively, a lower surface of each of actuators 101 may constitute a portion of deformable surface 102.

Lines 103 couple actuators 101 to actuator controller 104 so that actuator controller 104 controls operation of the actuators responsive to commands from system controller 114. Actuators may comprise, for example, rods that expand lengthwise when resistively heated, in which case lines 103 may comprise wires and actuator controller 104 comprises a power supply and controller circuitry. Alternatively, actuators 101 may comprise pneumatic or hydraulic cylinders, in which case lines 103 may be configured to transmit hydraulic or pneumatic pressure changes and actuator controller 104 may comprise a fluid supply, appropriate valves and pressure regulator. Actuators may be individually controlled by actuator controller 104, or actuated in predetermined groups.

Still referring to FIG. 1, support member 106 stabilizes and supports the moldable material as it is acted upon by actuators 101. In a preferred embodiment, the moldable material may comprise hydrophilic acrylic or other material known in the art to be suitable for contact lens manufacture. If the moldable material comprises a heat-curable polymer, then support member 106 also may contain heaters to enable curing of moldable material within cavity 105. Likewise, if the moldable material comprises a photo-curable polymer, then support member 106 also may be sufficiently transparent or translucent to allow passage of suitable light energy from lamp 118 to cure the moldable material within cavity 105. In addition, in a preferred embodiment, support member 106 is sufficiently transparent or translucent to permit measurement by measuring system 116 of the surface contour created by deformable surface 102, as described in more detail below.

Moldable material may be supplied to cavity 105 from reservoir 117 via inlet manifold 108 and valve 109. Control valve 109 selectively permits moldable material to pass from reservoir 117 through manifold 108 and into cavity 105. Exit manifold 107 provides an overflow channel for excess moldable material and a path to evacuate air or other matter from cavity 105.

In a preferred embodiment, prescriptive information, which specifies the desired wavefront characteristics of the contact lens to be fabricated, is input into system controller 114 via data input device 115. System controller preferably comprises a microprocessor and associated hardware and software that monitors and controls operation of the actuator controller 104, valve 109, measuring system 116 and curing means 118. Data input device 115 may comprise a keyboard that permits desired parameters to be input to system controller 114, or may comprise a data bus that couples system 50 to a system, per se known in the art, for determining the wavefront correction required for a given patient's eyes.

Measuring system 116 may be provided to confirm that the surface contour imposed on the moldable material by deformable surface 102 meets the specifications input by system controller 114, so as to produce a desired wavefront profile. Measuring system 116 preferably comprises a high resolution continuous fringe device that permits an accurate determination of the surface contour, although less accurate systems that utilize discrete measurements of the wavefront, such as Shack-Hartmann wavefront sensor, also may be employed.

Measuring system 116 tests the moldable material disposed in cavity 105 to determine the characteristics of the resultant wavefront produced by the moldable material in cavity 105. Output from measuring system 116 may be compared to the desired specification supplied by system controller 114. If the shape of the moldable material within cavity 105 is not within a desired range specified by system controller 114, system controller 114 directs actuator controller 104 to reposition actuators 101 to adjust the surface contour of the moldable material. This process may be iterated until a desired surface configuration is attained, and the moldable material is then cured.

Measuring system 116 may utilize a pure measurement system, such as in interferometer or other common optical metrology technique, to verify that the desired prescription has been obtained by the deformed moldable material 130. In an alternative embodiment, measuring system 116 may include a reference arm and an additional second arm having an actuator system that is unloaded. The interference between the reference arm and the second arm results in a single fringe, null fringe, or straight fringes, depending on the type of interferometer employed.

Once the moldable material contained within cavity 105 has been determined to attain a configuration with the range specified by system controller 114, the moldable material may be cured. Curing may be accomplished using any of a number of suitable methods, depending on the type of moldable material used. Preferably, the moldable material is cured by exposure to a light source, such as curing means 118, although heat source or chemical catalyst also may be used. Following curing by any appropriate method, the custom contact lens may be removed from reconfigurable mold 100.

In the embodiment of FIG. 1, the moldable material is cured by exposure to light of appropriate wavelength from curing means 118, illustratively, a lamp. To facilitate this curing step, support member 106 preferably is sufficiently transparent or translucent to the appropriate wavelength of light that the moldable material may be cured while contained within cavity 105. As noted above, forming support member 106 of a transparent material advantageously permits measuring system 116 to assess the quality of the wavefront imparted to the moldable material in-situ, and facilitates adjustment and correction of the wavefront surface prior to curing.

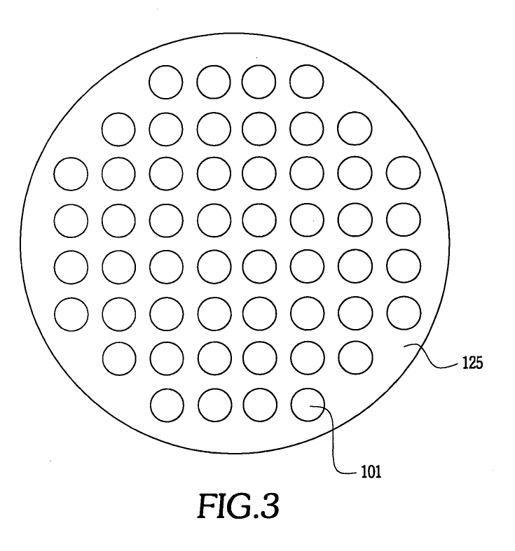

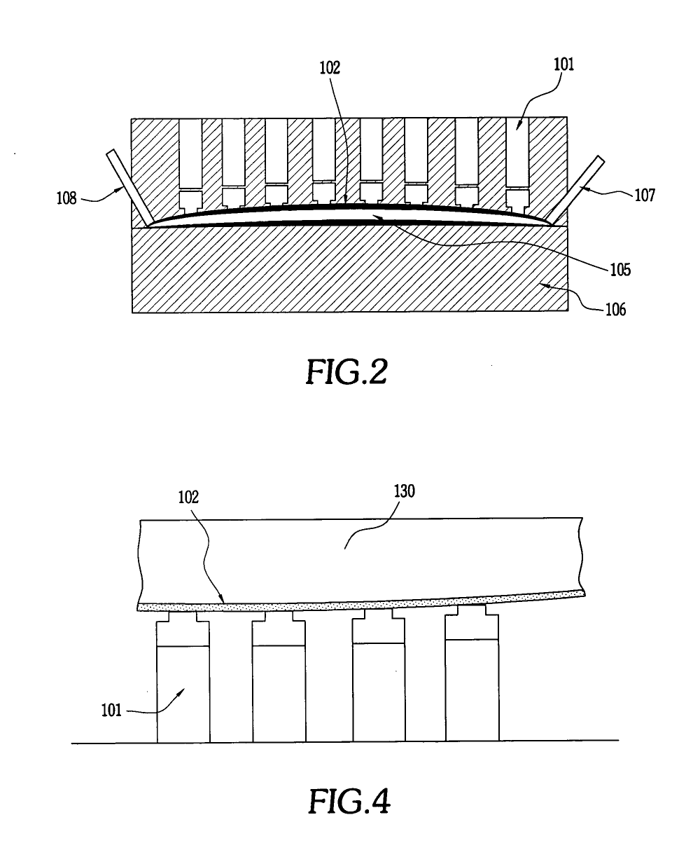

Referring now to FIGS. 2-4, further details of the reconfigurable mold 100 of the present invention are described. Moldable material enters the mold through inlet manifold 108. To facilitate this material transfer, suction may be applied to cavity 105 through exit manifold 7. Once the moldable material is disposed within cavity 105, deformable surface 102 is deflected by actuators 101 responsive to inputs from actuator controller 104 and system controller 114.

Actuators 101 preferably are configured to impart a selectably variable force and deflection to deformable surface 102 as required to accommodate different molding techniques. Actuators 101 preferably are hydraulically driven, although piezo-electric, electromagnetic, MEMS and mechanically driven devices, such as screws or driven pins, may be employed. Hydraulic actuators generally are preferred due to the speed of operation, forces that may be applied using the actuators, and range of motion.

FIG. 3 provides an exemplary view of the placement of actuators 101 within housing 125. Actuators 101 may be distributed over the area of deformable surface 102 in a variety of patterns, of which FIG. 3 depicts a regular grid-like pattern. Alternatively, other linear arrangements may be employed, including staggered rows or columns or radial patterns.

With respect to FIG. 4, deformable surface 102 preferably comprises a material that will not bond or adhere to the moldable material, thereby facilitating removal of the custom contact lens from mold 100 following curing. Deformable surface 102 preferably has sufficient thickness and rigidity that it tends to smooth and integrate localized deformations imposed by deflection of actuators 101, thereby providing smooth transition contours on the wavefront surface.

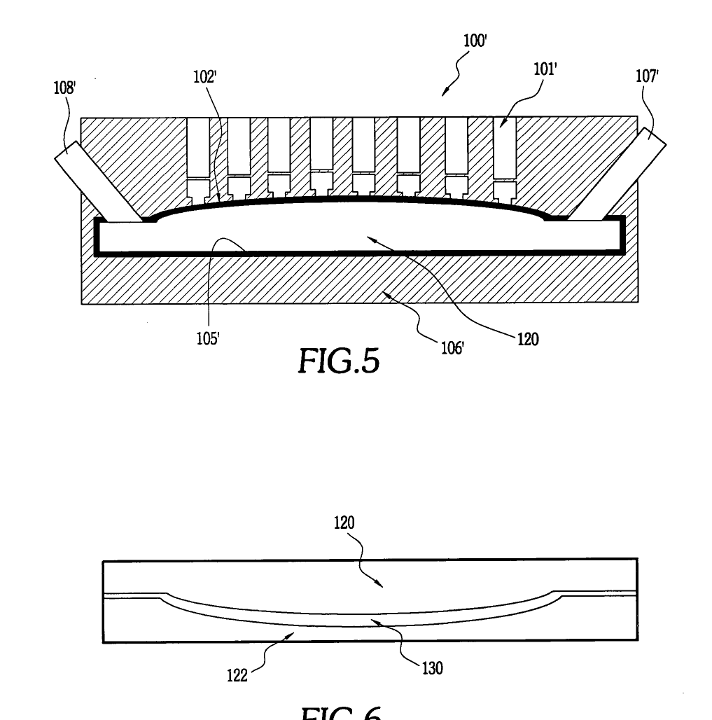

Referring now to FIGS. 5 and 6, use of the system of the present invention to make custom contact lens molds is now described. Reconfigurable mold 100′ is configured to produce a custom lens corneal mold component 120 (see FIG. 6) that may be subsequently used to cast or otherwise mold custom contact lenses. Material enters cavity 105′ through inlet manifold 108′, preferably aided by suction or other negative pressure applied through exit manifold 107′. Once cavity 105′ is filled, actuators 101′ are actuated to locally deflect deformable surface 102′ to the wavefront contour specified by the system controller. Mold 100′ also may be used make a custom lens anterior mold component 122, depicted in FIG. 6.

Support member 106′ preferably is sufficiently transparent or translucent that light of an appropriate wavelength may pass through the support member. This choice of material for support member 106′ also provides a path to measure the wavefront characteristic of the mold component 120 during the manufacturing process. Measurement of the mold component surface contour and adjustment of actuators 101′ may be performed iteratively using closed loop feedback to optimize the accuracy of the mold component surface.

FIG. 6 depicts a cross-sectional side view of custom mold components fabricated using the mold 100′ of FIG. 5. Custom mold components may be formed to facilitate fabrication of custom contact lens 130 appropriate for a patient requiring a patient-specific vision correction. For example, custom lens corneal mold component 120 may be designed to create a molded lens 130 to fit the topography of a specific patient's eye. Likewise, custom lens anterior mold component 122 may be designed to create a molded lens 130 to provide a predetermined degree of vision correction when taking into account the topography of the corneal wavefront.

Preferably, channels are formed in one of both of the custom lens corneal mold component 120 and custom lens anterior mold component 122. Hence, when these components are placed together as shown in FIG. 6, the moldable material has an inlet channel leading into the cavity 105′, as well as an exit channel, which may also be used for overflow or to apply suction.

To create a molded lens 130 using the custom molds, the moldable material is preferably deposited in cavity 105′ through the inlet channel of the mold. Once the cavity 105′ is filled, the material may be cured, such as by exposure to light or heat, as described above. To facilitate curing by light, the custom lens corneal mold component 120 and custom lens anterior mold component 122 may comprise materials transparent or translucent to the appropriate wavelength of light required to cure the moldable material.

In addition to making custom lens corneal mold component 120 and custom lens anterior mold component 122 together capable of forming a single molded lens 130, the present invention may be used to create larger templates having several cavities, which are therefore capable of fabricating a plurality of lenses simultaneously.

When forming the custom lens corneal mold component 120 and custom lens anterior mold component 122, it is preferred that these components be designed to compensate for systematic variations, such as shrinkage or swelling that may occur with various types of materials and when exposed to variations in environment, such as temperature, pressure, and moisture.

It will be appreciated by one of skill in the art of contact lens design that the present invention advantageously may be employed to create any number of different types of custom optics, including optics having multiple circumferential elements.

While preferred embodiments of the invention are described above, it will be apparent to one skilled in the art that various changes and modifications may be made. The appended claims are intended to cover all such changes and modifications that fall within the true spirit and scope of the invention.

1. Apparatus for molding a custom contact lens comprising:
a housing that partially encloses a cavity;
a deformable surface coupled to the housing to define a wall surface of the cavity;
an array of actuators disposed in the housing in contact with the deformable surface to selectively impart localized deflections to the deformable surface to define a surface contour; and
an actuator controller coupled to the array of actuators to control actuation of the array of actuators.

2. The apparatus of claim 1 further comprising a system controller that specifies a desired deformation of the deformable surface.

3. The apparatus of claim 1 further comprising a support member that partly defines the wall surface of the cavity.

4. The apparatus of claim 3 wherein the support member is transparent to light of specified wavelengths.

5. The apparatus of claim 4 further comprising a measuring system that measures the surface contour.

6. The apparatus of claim 4 further comprising a curing means for curing a moldable material deposited within the cavity.

7. The apparatus of claim 6 wherein the curing means comprises a heat source.

8. The apparatus of claim 6 wherein the curing means comprises a light source.

9. The apparatus of claim 5 wherein the measuring system is an interferometer.

10. The apparatus of claim 1 further comprising a reservoir of moldable material coupled to the housing.

11. Apparatus for molding a custom contact lens mold comprising:
a housing that partially encloses a cavity;
a deformable surface coupled to the housing to define a wall surface of the cavity;
an array of actuators disposed in the housing in contact with the deformable surface to selectively impart localized deflections to the deformable surface to define a surface contour; and
an actuator controller coupled to the array of actuators to control actuation of the array of actuators.

12. The apparatus of claim 11 further comprising a system controller that specifies a desired deformation of the deformable surface.

13. The apparatus of claim 11 further comprising a support member that partly defines the wall surface of the cavity.

14. The apparatus of claim 13 wherein the support member is transparent to light of specified wavelengths.

15. The apparatus of claim 14 further comprising a measuring system that measures the surface contour.

16. The apparatus of claim 14 further comprising a curing means for curing a moldable material deposited within the cavity.

17. A method for forming a custom contact lens comprising:
providing a reconfigurable mold comprising a deformable surface that partly defines a wall surface of a cavity and an array of actuators configured to impart localized deflections on the deformable surface;
inserting moldable material into the cavity; and
actuating the array of actuators to deform the deformable surface to impart a specified surface contour on the moldable material to produce a desired wavefront; and
curing the moldable material to form the custom contact lens.

18. The method of claim 17 further comprising inputting information for a desired custom contact lens configuration.

19. The method of claim 18 further comprising translating the information into localized deflections of the array of actuators.

20. The method of claim 17 further comprising:
measuring the surface contour imparted to the moldable material with a measuring device;
comparing a measured surface contour to the specified surface contour; and
repositioning at least some of the array of actuators prior to curing the moldable material.
